(19) United States
(12) Patent Application Publication
(10) Pub. No.: US 2005/0021704 A1
(43) Pub. Date: Jan. 27, 2005

(54) Intercoupling apparatus for server computer systems

(76) Inventors: Thane M. Larson, Roseville, CA (US); Loren M. Koehler, Fair Oaks, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/460,288

(22) Filed: Jun. 11, 2003

(51) Int. Cl. G06F 15/173

(52) U.S. Cl. 709/223

(57) ABSTRACT

An intercoupling apparatus for server computer systems. The intercoupling apparatus can be used with bladed or rack mountable server computer systems. The intercoupling apparatus comprises a substantially rigid coupling element for coupling a plurality of rack mountable server computer systems in a network topology. A wide variety of networking topologies can be implemented, including star and mesh topologies. The intercoupling apparatus further comprises an on-board management function integral to the substantially rigid coupling element.

### TECHNICAL FIELD

Embodiments in accordance with the present invention relate to intercoupling server computer systems.

### BACKGROUND ART

Server computer systems are generally high end computer systems designed to retrieve or process information for large numbers of users. Server computer systems typically are designed to operate without direct user interface features, for example, keyboards or video displays. Server computer systems are frequently located in large groups sometimes known as server “farms,” and are generally physically inaccessible to all but technical maintenance personnel.

Many server computer systems are rack mountable. For example, the systems have been designed and manufactured to mount in a standard sized rack. A rack usually consists of two vertical rails separated by a standard distance, for example 19 inches. Rack mountable computers are usually constructed with protective covers over internal circuitry. Rack mountable computers are typically of a standard height, or integral multiples of a standard height. For example, many server computers are “1U” in height, or 1.75 inches in height. Rack mountable computers typically have minimal manual controls, e.g., a power switch, and usually have input/output connections on the front and/or the back. Such input/output connections typically correspond to widely accepted industry standards, e.g., an RJ-45 connector type for networking.

A rack of rack mountable server computers can easily accommodate 30 or more separate computer systems. In addition, such a rack typically comprises one or more network hubs, routers and/or switches used to couple the server computers to client computers, for example via a local area network (LAN) or the internet.

Conventionally, each sever computer in a rack is coupled to one or more other devices in the rack, e.g., other servers and/or networking equipment, via individual patch cables. High availability arrangements of cabling, e.g., dual star or dual star with redundancy (“dual-dual star”), can multiply the number of cables per computer. Consequently, a rack may comprise many times more individual intercoupling cables than systems.

Unfortunately, such an arrangement of cables produces a complex “rat's nest” of wiring that must be assembled and maintained manually. It is often difficult to determine which cable couples two specific devices. As a manual process, it is frequently error prone, producing errors in intercoupling and/or errors in determining which server corresponds to a specific network address.

In addition, the ever present trend of advancing networking technologies and speeds, e.g., low voltage differential signaling (LVDS), serializer/de-serializer (SERDES) technology, Ethernet 1000X, Etherinet 1000CX and 10 Gigabit XAUI and higher frequencies, challenge the physical capabilities, e.g., length and impedance match, of individual patch cabling. In addition, individual patch cables become significantly more expensive as networks increase in frequency.

A type of server computer system known as a “blade” or “bladed” server has been developed to mitigate some of the challenges of intercoupling rack mounted servers. A bladed server is generally comprised of a plurality of board-level computer systems inserted into a card cage. The board level computer systems are generally functionally equivalent to the rack mountable computer systems. However, the board level computer systems typically lack individual protective enclosures and generally do not have industry standard input/output connectors.

The card cage typically comprises a printed wiring board backplane, or “mother board” connecting system into which the board level computers connect. The board level computers typically comprise a card edge connector that plugs into a receptacle on the backplane. In general, a blade server will not function without a corresponding backplane.

Unfortunately, such blade servers typically are proprietary. For example, all components must be purchased from a single supplier, and the connector and signal definitions do not comply with industry standards. This limits or eliminates an ability to optimize a server installation by choosing among a variety of competitive offerings from a number of competitive suppliers. Further, blade servers are typically more expensive than similar rack mountable servers, due in part to a lack of competition. In addition, rack-mountable servers generally comprise a larger physical volume (per server) than blade servers. Such a larger physical volume can enable increased functionality, for example by accommodating a greater number of components. Further, blade servers are limited in scalability (e.g., the number of servers is limited and/or the total power available and/or dissipated by such servers is limited) by their blade enclosure.

Thus an apparatus for intercoupling server computer systems is highly desirable. A further desire exists to meet the previously identified desire in an intercoupling apparatus that comprises an integral networking switch function. Yet another desire exists to meet the previously identified desires in a manner that is compatible and complimentary with convention configurations of server computer systems.

### SUMMARY OF THE INVENTION

Embodiments in accordance with the present invention provide an apparatus for intercoupling server computer systems. Further embodiments provide an intercoupling apparatus that comprises an on-board management function. Yet other embodiments achieve the previously identified capabilities in a manner that is compatible and complimentary with conventional configurations of server computer systems.

An intercoupling apparatus for server computer systems is disclosed. The intercoupling apparatus can be used with bladed or rack mountable server computer systems. The intercoupling apparatus comprises a substantially rigid coupling element for coupling a plurality of rack mountable server computer systems in a network topology. A wide variety of networking topologies can be implemented, including star and mesh topologies. The intercoupling apparatus further comprises an on-board management function integral to the substantially rigid coupling element.

### BRIEF DESCRIPTION OF THE DRAWINGS

FIG. 1 illustrates a block diagram of an arrangement of server computer systems, in accordance with embodiments of the present invention.

FIG. 2 illustrates a block diagram of two embodiments of an intercoupling apparatus, in accordance with embodiments of the present invention.

FIG. 3 illustrates a stack of server computer systems coupled by intercoupling apparatuses, in accordance with embodiments of the present invention.

### BEST MODES FOR CARRYING OUT THE INVENTION

While embodiments in accordance with the present invention will generally be described herein in terms of rack mountable server computer systems, it is to be appreciated that embodiments in accordance with the present invention are well suited to blade type server computer systems. Consequently, such embodiments are to be considered within the scope of the present invention.

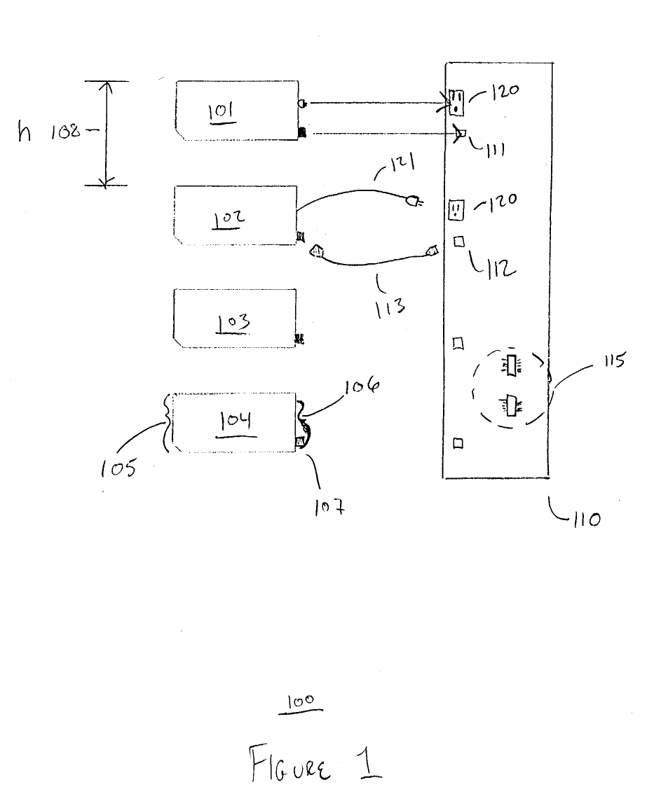

FIG. 1 illustrates a block diagram of an arrangement 100 of server computer systems, in accordance with embodiments of the present invention. FIG. 1 illustrates four server computer systems, 101-104. It is to be appreciated, however, that embodiments in accordance with the present invention are well suited to a wide variety in the number of server computers systems. Server computer systems 101-104 are typically substantially similar. However, an advantage of rack mountable servers is an ability to mix and match server computer systems of differing capabilities and/or from differing suppliers to optimize such an arrangement, and such differing server computer systems are well suited to embodiments in accordance with the present invention.

Sever computer systems 101-104 typically have a face referred to as a “front” and a side referred to as a “back.” Server computer system 104 is labeled to indicate an exemplary front face 105 and back side 106. The front of a sever computer system can have user accessible functions, e.g., a power switch, indicating lights and a floppy disk drive. The back of a server computer system generally comprises a plurality of networking connectors, e.g., networking connector 107.

The sever computer systems 101-104 are generally designed to be mounted with a standard vertical separation, height 108. An industry standard for rack mountable server computer systems is referred to as “1U,” which is 1.75 inches. Generally, the placement of networking connector 107 is not standardized, especially between different suppliers of sever computer systems. However, it is to be appreciated that many such placements can be similar, and that the placement of such connectors can be substantially identical for substantially identical server computer systems.

Arrangement 100 further comprises intercoupling apparatus 110. Intercoupling apparatus 110 is shown rotated from its normal alignment so as to better illustrate certain aspects of intercoupling apparatus 110. When coupled to a plurality of server computer systems, e.g., server computer systems 101-104, intercoupling apparatus 110 would normally be aligned such that its face is parallel to the back side(s) of such server computer systems. The normal alignment of intercoupling apparatus 110 with respect to server computer systems 101-104 is perpendicular to the plane of FIG. 1.

Intercoupling apparatus 110 can be a printed wiring board of well-known construction. Intercoupling apparatus 110 is also well suited to flexible, or semi-flexible wiring technologies, e.g., constructed of polyimide materials. Intercoupling apparatus 110 can also be compatible with optical transmission of signals. Intercoupling apparatus 110 comprises a plurality of connectors for coupling with server computer systems. For example, intercoupling apparatus 110 can comprise a connector 111 that couples directly with a mating connector of a server computer system. For direct coupling to rack mountable server computer systems, connector 111 should be an industry standard type of connector, e.g., a member of the RJ-45 connector family or an optical connector.

Alternatively, intercoupling apparatus 110 can comprise a connector 112 for coupling with a server computer system via a short “pigtail” cable 113. Cable 113 can generally be shorter than conventional patch cables used to interconnect a plurality of rack-mounted computers and/or networking equipment. For example, cable 113 need only span a distance between the back of server computer system 102 and intercoupling apparatus 110. Under the conventional art, such a cable for connecting two server computer systems or a server computer system to a discrete network switch device could have to span many “1U” distances, for example, several meters. It is to be appreciated that intercoupling apparatus 110 can comprise multiple connectors of differing types per server computer system, in accordance with embodiments of the present invention.

Intercoupling apparatus 110 comprises wiring, e.g., printed circuit traces, that couples a plurality of server computer systems in a network topology. For example, the server computers systems can be networked in a star, dual star, dual-dual star or mesh network topology. It is to be appreciated that embodiments in accordance with the present invention are well suited to other networking topologies. The wiring of intercoupling apparatus 110 can be compatible with a variety of physical layers, e.g., low voltage differential signaling (LVDS) or Intelligent Chassis Management Bus (ICMB), and can support a variety of data link layer protocols, for example, Ethernet BaseT, Ethernet 1000X and 10 Gigabit XAUI, Fibrechannel and Infiniband.

In accordance with embodiments of the present invention, intercoupling apparatus 110 can further comprise circuitry and other elements of a network switch function 115. Conventionally, an arrangement of server computer systems includes a discrete network switch device. Typically, such a network switch device is packaged similarly to the server computer systems, e.g., as a rack mountable switch or as a “blade.” Usually, one or more discrete network switch devices are included in each rack or blade stack of server computer systems. An intercoupling apparatus 110 with switch function 115 eliminates a need for such a discrete network switch device. In addition, because the majority of the couplings among server computers and switch function 115 are contained within intercoupling apparatus 110, generally more complex and higher function networking topologies can be implemented with less effort and greater reliability than under the conventional art.

In accordance with embodiments of the present invention, intercoupling apparatus 110 can further distribute power to coupled server computer systems. Such power can be, for example, a coupling to AC mains. Alternatively, intercoupling apparatus 110 can supply “bulk” power, e.g., 48 volts DC, to coupled server computer systems. Power couplings of intercoupling apparatus 110 can comprise cables, e.g., that are attached to intercoupling apparatus 110. Power couplings of intercoupling apparatus 110 can further comprise wiring, e.g., power “planes,” of intercoupling apparatus 110.

Such distribution of power can simplify power wiring, particularly within a group of rack mounted server computer systems. For example, under the conventional art it can be necessary to run an AC power cable from each server computer system to an outlet or “power strip.” Such cabling can be eliminated by a direct connection to an AC connector 120 of intercoupling apparatus 110 or reduced to a short “pigtail” cable 121 to intercoupling apparatus 110 in accordance with embodiments of the present invention. In addition, there can be power efficiencies associated with distribution of bulk power, for example, due to decreased conversion losses.

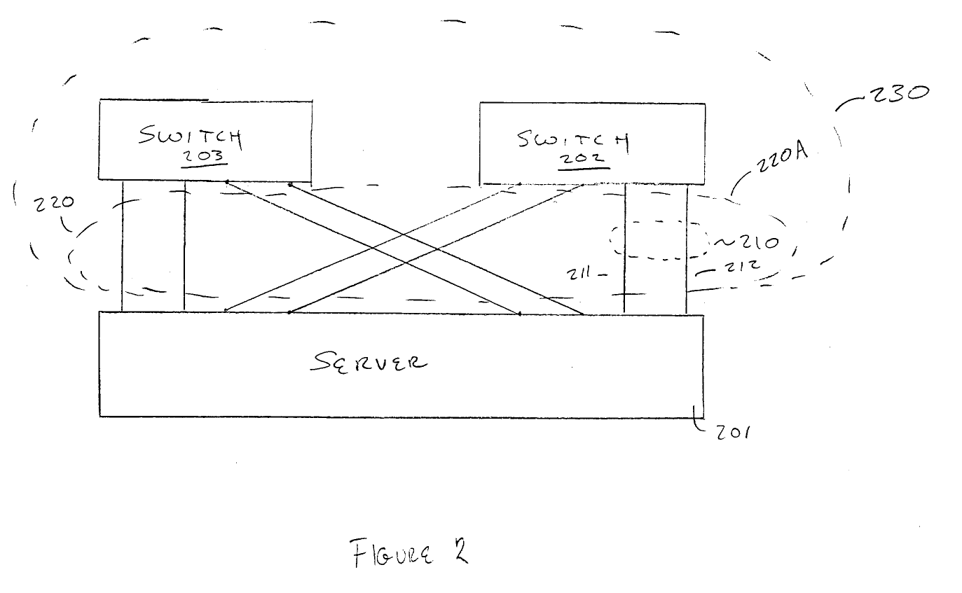

FIG. 2 illustrates a block diagram of two embodiments of an intercoupling apparatus, in accordance with embodiments of the present invention. FIG. 2 illustrates a single server computer system 201 coupled to two network switches 202, 203, in a high availability dual star network configuration of Ethernet 1000X. It is appreciated that embodiments in accordance with the present invention are well suited to a plurality of server computer systems, a plurality of network switches, different network topologies and a wide variety of types of networks.

Physical links 211 and 212 form a communication channel 210. The illustrated exemplary dual star interconnection 220 represents two primary communication channels and two redundant communication channels, with a total of eight physical links. In accordance with embodiments of the present invention, intercoupling apparatus 220A comprises wiring to embody dual star interconnection 220. Switches 202 and 203 are not part of intercoupling apparatus 220A. Switches 202 and 203, can be, for example, stackable units within a stack of server computer systems.

Under the conventional art, coupling a single rack mounted server computer system to two network switch elements in a dual star interconnection similar to dual star interconnection 220 takes eight cables. Coupling numerous rack mounted servers, e.g., 40, to multiple switch elements can require hundreds of cables per such rack in a complex and confusing arrangement. For example, some cables of a server computer system can go “up” and some can go “down.” Most cables will cross over many other cables. In such an arrangement, it is difficult to connect all cables correctly, and even more difficult to determine the manner of interconnection of a particular server computer system within such an installed maze of cables.

In contrast, embodiments in accordance with the present invention can require no such cables, or very short “pigtail” cables that clearly run from a rack mounted unit to a corresponding connector on an intercoupling apparatus. Installation, maintenance and diagnostics are thereby greatly improved.

As described previously with respect to FIG. 1, an intercoupling apparatus can further comprise network switch elements, e.g., networking switches 203 and 202. This configuration is illustrated by intercoupling apparatus 230. Intercoupling apparatus 230 further simplifies “cabling” a rack of server computer systems. In addition, intercoupling apparatus 230 can increase the density of server computers in a rack, as spaces need no longer be taken by rack mounted network switch elements.

Advantageously, with intercoupling apparatus 230 there is inherent knowledge of the couplings between particular server computer systems and particular networking switch elements. For example, it is known that the first port of networking switch 202 is coupled to the topmost server computer system coupled to intercoupling apparatus 230. Under the conventional art, such a mapping of couplings is highly influenced by human installers. For example, an installer typically maps such couplings as they are made. In other instances, an installer follows a pre-determined map of couplings. In either case, the actual couplings and/or the documentation of such couplings is highly error prone.

In contrast, embodiments in accordance with the present invention can pre-define couplings with great accuracy and high repeatability, greatly improving installation, maintenance and diagnostics of racks of server computer systems.

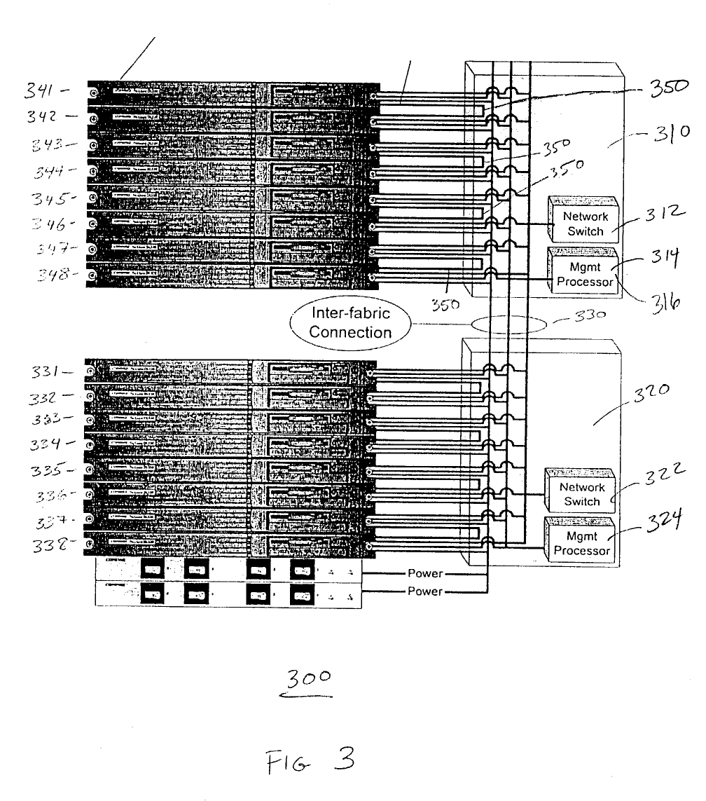

FIG. 3 illustrates a stack 300 of server computer systems coupled by intercoupling apparatuses, in accordance with embodiments of the present invention. Server computer systems 331-341 are “1U” stackable server computer systems. It is to be appreciated that other stacking heights, e.g., “2U,” and combinations of stacking heights are well suited to embodiments in accordance with the present invention. Server computer systems 331-338 are coupled to network switch 322 of intercoupling apparatus 320. Server computer systems 341-348 are coupled to network switch 312 of intercoupling apparatus 310.

Power for server computer systems 331-338 is coupled through intercoupling apparatus 320, and power for server computer systems 341-348 is coupled through intercoupling apparatus 310. Intercoupling apparatuses 310 and 320 can couple multiple independent power supplies to the coupled server computer systems. The power supplies can be coupled in a “dot OR” configuration, or switched, for example, in the event of failure of a power supply. In this manner, seamless power supply redundancy can be provided to coupled server computer systems.

In accordance with embodiments of the present invention, intercoupling apparatuses 310 and 320 can be coupled via inter-fabric connection 330. Inter-fabric connection 330 couples network switch 312 to network switch 322. Such a coupling can be made, for example, using well-known “stacking” capabilities of network switches. It is to be appreciated that intercoupling apparatus 310 can similarly couple to another intercoupling apparatus (not shown) “above” intercoupling apparatus 310. Similarly, intercoupling apparatus 320 can similarly couple to another intercoupling apparatus (not shown) “below” intercoupling apparatus 320. In this novel manner, a plurality of intercoupling apparatuses can be coupled together or “stacked,” intercoupling a plurality of server computer systems.

In accordance with other embodiments of the present invention, intercoupling apparatuses, e.g., intercoupling apparatuses 310 and 320, can be coupled by a networking link, e.g., a local area network (LAN) which is distinct from a stacking link of a network switch. Such network coupling can be of the same type used in coupling servers to the intercoupling aparatus(es), or such network coupling can be of a different type of network. A LAN port on an intercoupling apparatus can be dedicated for coupling a plurality of intercoupling apparatuses.

Management processor 314 of intercoupling apparatus 310 provides management functions for intercoupling apparatus 310 and server computer systems and/or networking elements coupled thereto. Management processor 324 provides comparable functions for intercoupling apparatus 320 and its associated systems. In general, management processor is capable of communicating with all systems coupled to intercoupling apparatus 310. Such communication should not enable server computer systems of intercoupling apparatus 310 to communicate directly with one another for security reasons. Management processor 314 can have a capability to disable access of other management processors, e.g., a management processor of a coupled intercoupling apparatus, to servers coupled directly to intercoupling apparatus 310. Such a granularity of control can enhance security.

Management processor 314 can be used to monitor the function and/or operation of systems attached to intercoupling apparatus 310. For example, management processor 314 can determine identifying information of server computer systems coupled to intercoupling apparatus 310. This information can be reported, for example via pull or push technologies, to remote network managers. Such inventory information is extremely valuable, for example, to managers of a server farm comprising many stacks comprising many server computer systems.

Management processor 314 can also control indicators, e.g., audio and/or visual indicators, to identify intercoupling apparatus 310 and/or a particular server computer system 341-348 in response to particular circumstances. For example, if network managers desire to remove server computer system 344 from the server farm, management processor 314 can be instructed to control indicia to identify intercoupling apparatus 310 and server computer system 344. Such aids to finding a particular server computer system are generally not available under the conventional art.

Some organizations, e.g., telecommunications common carriers, require an audible warning to indicate a failure, for example of a server computer system. Management processor 314 can enable such warnings independently of whether a particular server computer system has such audible warning capabilities. As a beneficial result, management processor 314 can open up such markets to all server computer systems.

Under the conventional art, one server computer system in a rack would typically perform a “rack management” function. Unfortunately, empowering a server computer system for such a function creates numerous security problems. Since management processor 314 is not associated with a particular server computer system (or the entities hosted on a particular server computer system), it can perform such management functions with significantly less security exposure.

Management processor 314 can also control power to server computer systems 341-348. For example, management processor 314 can turn off server computer system 344 if server computer system 344's resources are not needed. In addition, management processor 314 can configure server computer systems 341-348. An ability to control power distribution to server computer systems in conjunction with an ability to configure such systems can enable management processor 314 to load balance among server computer systems 341-348. It is appreciated that server computer systems typically are operable at a plurality of power consumption levels corresponding to functional capabilities. Management processor 314 can optimize the configuration and power consumption of such server computer systems, for example via an Advanced Configuration and Power Interface (ACPI), to optimize function with respect to power consumption. It is appreciated that power consumption and the ability to remove heat are major concerns to operators of server computer systems. Embodiments in accordance with the present invention can enable better management of power consumption and/or heat generation from a plurality of server computer systems.

Under the conventional art, a failure of a power supply for a group of server computer systems generally causes each server computer system to generate a failure message. It is not uncommon for each such server computer system to report to a different entity, e.g., a corporation using the server computer system to host a web site. Consequently, one power supply failure can typically generate numerous error reports to numerous different entities. Typically, such reports will eventually make their way back to the server farm operators. The operators then have to investigate such reports, determine where a server computer system being used by the reporting party is physically located, and manually check the power supply. If the reports back to the farm operator are delayed and/or separated in time, the operator can be caused to investigate a problem multiple times, only to determine that it has already be remedied.

In contrast, management processor 314 can be coupled to a plurality of power supplies providing power for server computers 341-348. In the event of failure of a power supply, management processor 314 can electrically isolate the failing device and/or notify a remote manager of such failure. Management processor 314 can also provide an indication among multiple power supplies of a failing device. Because such reporting is managed by management processor 314, a single entity, and not a plurality of server computer systems, the notification can be more direct and accurate, advantageously leading to greater efficiencies in the operation of a server farm.

Intercoupling apparatus 310 further comprises high availability side band couplings 350. High availability side band couplings 350 comprise a number of physical links, e.g., ten differential pairs (5 transmit and 5 receive), used to communicate between pairs of server computer systems. High availability side band couplings 350 enable server computer systems, e.g., server computer systems 341 and 342, to be paired for high-availability configurations in which two server computer systems can be operated in lock step. High availability side band couplings 350 generally do not provide any active circuitry; rather a typical high availability side band coupling comprises a physical coupling between two server computer systems.

Intercoupling apparatus 310 can further comprise location identification information 316, e.g., as a part of management processor 314. Location identification information 316 should include identifying information for intercoupling apparatus 310, e.g., a serial number. Location identification information 316 can also comprise geographic location information. Geographic location information can be encoded to computer readable media using the COMMON LANGUAGE® location codes (CLLI), commercially available from Telcordia Technologies of New Jersey, which are widely used in the telecommunications industry. Other means of encoding geographic location are well suited to embodiments in accordance with the present invention. Location identification information 316 can be made available to remote network managers, for example, via telnet, Simple Network Management Protocol (SNMP) and/or over an Intelligent Chassis Management Bus (ICMB).

Embodiments in accordance with the present invention provide an apparatus for intercoupling server computer systems. Further embodiments provide an intercoupling apparatus that comprises an integral networking switch function. Yet other embodiments achieve the previously identified capabilities in a manner that is compatible and complimentary with conventional configurations of server computer systems.

Embodiments in accordance with the present invention, intercoupling apparatus for server computer systems, are thus described. While the present invention has been described in particular embodiments, it should be appreciated that the present invention should not be construed as limited by such embodiments, but rather construed according to the below claims.

1. An intercoupling apparatus comprising:
a substantially rigid coupling element for coupling a plurality of rack mountable server computer systems in a network topology;
a network management processor integral to said coupling element and coupled to said plurality of rack mountable server computer systems; and
wherein said network management processor is for performing a management function of said plurality of rack mountable server computer systems.

2. The apparatus of claim 1 further comprising a high availability side band coupling for coupling two of said plurality of rack mountable server computer systems.

3. The apparatus of claim 1 further comprising a coupling for power for said plurality of rack mountable server computer systems.

4. The apparatus of claim 1 wherein said management function is reporting a location code of said apparatus.

5. The apparatus of claim 1 wherein said management function is load balancing among said plurality of rack mountable server computer systems.

6. The apparatus of claim 1 wherein said management function is notifying a management entity in the event of a failure of a power supply coupled to said apparatus.

7. The apparatus of claim 1 wherein said management function is generating an indicator in the event of a failure of a device coupled to said apparatus.

8. The apparatus of claim 1 wherein said management function is generating an indicator for identification of a device coupled to said apparatus.

9. An intercoupling apparatus comprising:
a substantially rigid coupling element for coupling a plurality of server computer systems in a network topology;
a networking switch function integral to said coupling element;
a network management processor integral to said coupling element and coupled to said plurality of rack mountable server computer systems; and
wherein said network management processor is for performing a management function of plurality of rack mountable server computer systems.

10. The apparatus of claim 9 further comprising a high availability side band coupling for coupling two of said plurality of server computer systems.

11. The apparatus of claim 9 further comprising a coupling for power for said plurality of server computer systems.

12. The apparatus of claim 9 wherein said management function is reporting a location code of said apparatus.

13. The apparatus of claim 9 wherein said management function is load balancing among said plurality of server computer systems.

14. The apparatus of claim 9 wherein said management function is notifying a management entity in the event of a failure of a power supply coupled to said apparatus.

15. The apparatus of claim 9 wherein said management function is generating an indicator in the event of a failure of a device coupled to said apparatus.

16. The apparatus of claim 9 wherein said management function is generating an indicator for identification of a device coupled to said apparatus.

17. A group of server computer systems comprising:
a plurality of server computer systems;
a substantially rigid coupling element for coupling a plurality of server computer systems in a network topology;
a networking switch function integral to said coupling element;
a network management processor integral to said coupling element and coupled to said plurality of rack mountable server computer systems; and
wherein said network management processor is for performing a management function of plurality of rack mountable server computer systems.

18. The apparatus of claim 17 further comprising a high availability side band coupling for coupling two of said plurality of server computer systems.

19. The apparatus of claim 17 further comprising a coupling for power for said plurality of server computer systems.

20. The apparatus of claim 17 wherein said server computer systems are rack mountable server computer systems.
